(19) United States
(12) Patent Application Publication
(10) Pub. No.: US 2024/0380091 A1
(43) Pub. Date: Nov. 14, 2024

(54) METAL INJECTION FILTER AND MANUFACTURING METHOD

(71) Applicants: PROSE TECHNOLOGIES (SUZHOU) CO., LTD., Suzhou (CN); PROSE TECHNOLOGIES LLC, Mount Olive, NJ (US)

(72) Inventors: Ze YIN, Suzhou (CN); Qiang LI, Suzhou (CN)

(21) Appl. No.: 18/779,310

(22) Filed: Jul. 22, 2024

Related U.S. Application Data
(63) Continuation of application No. PCT/CN2022/137407, filed on Dec. 8, 2022.

(30) Foreign Application Priority Data
Jan. 29, 2022 (CN) 202210111286.5

(51) Int. Cl. H01P 11/00; H01P 1/20

(52) U.S. Cl. CPC H01P 11/008; H01P 1/20

(57) ABSTRACT

A metal injection filter includes a resonator chamber body and a plurality of resonators. The resonator chamber body is an enclosure that forms a resonance chamber. The plurality of resonators are mounted in the resonance chamber. At least one resonator of the plurality of resonators is molded by a metal injection molding process.

### CROSS-REFERENCES TO RELATED APPLICATIONS

The present disclosure is a continuation of International Application No. PCT/CN2022/137407, filed on Dec. 8, 2022, which claims priority to Chinese Application No. 202210111286.5 filed on Jan. 29, 2022, the entire content of all of which are incorporated herein by reference.

### TECHNICAL FIELD

The present disclosure generally relates to the filter field and, more particularly, to a metal injection filter and a manufacturing method.

### BACKGROUND

A filter is a frequency-selection device, which allows a specific frequency component in a signal to pass through while significantly attenuating other frequency components. With the frequency selection function of the filter, interference noise can be eliminated, or spectrum analysis can be performed.

Currently, the filter industry typically manufactures the filter in a machining method and die-casting method. In the machining method, manufacturing time is long, the material utilization rate is low, and the cost is high. The machining method is suitable for products with a small batch size and a large dimension. The die casting is a metal casting process. An internal chamber of a mold is used to apply high pressure on the melted metal. The mold is generally manufactured by an alloy with higher strength. The manufacturing costs of the casting equipment and mold are high, and the manufacturing cycle is long. Thus, the die-casting process is often used to manufacture a large amount of products. The batch production of the housing and resonator of the conventional metal filter are often die-cast using aluminum alloy. A mold-removing tilt angle is necessary due to the characteristics of die casting. Thus, the internal dimension of the chamber becomes smaller, and the radiofrequency performance is reduced.

In recent years, as technology continues to be developed, requirements for the dimension and performance of the filter are continuously increasing. The existing machining method and the die-casting method no longer satisfy the requirements of a new filter.

### SUMMARY

For the above technical problem, the purpose of the present disclosure is to provide a metal injection filter and a manufacturing method. At least one resonator of the metal injection filter is molded by a metal injection molding process to cause the resonator to have a higher process precision, which helps improve the overall performance of the filter.

One aspect of the present disclosure provides a metal injection filter including a resonator chamber body and a plurality of resonators. The resonator chamber body is an enclosure that forms a resonance chamber. The plurality of resonators are mounted in the resonance chamber. At least one resonator of the plurality of resonators is molded by a metal injection molding process.

Another aspect of the present disclosure provides a method for manufacturing a metal injection filter. The method includes mixing metal powder and binder with a predetermined ratio to form a mixture, mixing the mixture to a liquid state, injecting the mixture that is in the liquid state into a filter element mold, after removing the binder of the mixture, sintering the mixture to form a filter element, and assembling the filter element and a filter body to form the filter.

Compared to the existing technology, the metal injection filter and the manufacturing method of the present disclosure can have the following beneficial effects.

1. In the metal injection filter and the manufacturing method of the present disclosure, at least one resonator of the metal injection filter is injection molded in the metal injection process to cause the resonator to have a higher processing precision, which helps improve the overall performance of the filter.

2. In the metal injection filter and the manufacturing method of the present disclosure, at least one resonance unit is arranged in the resonance chamber of the metal injection filter. The resonance unit can include at least two resonators. The at least two resonators of the resonance unit can be integrally metal injection molded to realize that the at least two resonators are coupled with a high precision.

3. In the metal injection filter and the manufacturing method of the present disclosure, the resonator chamber body of the metal injection filter and the plurality of resonators in the resonance chamber are integrally formed in the metal injection molding process, filters with miniaturization, lightweight, high performance, and high integration can be achieved with smaller extreme dimensions and more precise dimensional tolerances.

### BRIEF DESCRIPTION OF THE DRAWINGS

Embodiments of the present disclosure are described in connection with the accompanying drawings in a specific and understandable method to further describe the features, technical features, advantages, and implementations of the present disclosure.

FIG. 1 and FIG. 2 are schematic perspective structural diagrams of a metal injection filter according to some embodiments of the present disclosure.

FIG. 3 is a schematic exploded structural diagram of a metal injection filter according to some embodiments of the present disclosure.

FIG. 4 is a schematic structural diagram of a top view of a resonator chamber of a metal injection filter according to some embodiments of the present disclosure.

FIG. 5, FIG. 6, FIG. 7, FIG. 8, FIG. 9, FIG. 10, and FIG. 11 are schematic structural diagrams of a resonance unit of a metal injection filter according to some embodiments of the present disclosure.

FIG. 12 is a schematic perspective structural diagram of a resonance unit of a metal injection filter according to some embodiments of the present disclosure.

FIG. 13 is a schematic flowchart of a manufacturing method of a metal injection filter according to some embodiments of the present disclosure.

Reference numerals:

Resonator chamber body 10, Resonance chamber 11, First connector 12, First tap 121, Second connector 13, Second tap 131, First positioning member 14, Resonator 20, Resonance unit 30, Fame body 31, Container chamber 310, First container chamber 3101, Second container chamber 3102, Third container chamber 3103, Partition 32, Coupling window 320, First resonator 33, Second resonator 34, Third resonator 35, Top cover 41, Bottom cover 42, and Adjustment module 43.

### DETAILED DESCRIPTION OF THE EMBODIMENTS

To describe embodiments of the present disclosure or the technical solution of the existing technology in detail, embodiments of the present disclosure are described according to the accompanying drawings. Apparently, the accompanying drawings below are merely some embodiments of the present disclosure. For those ordinary skills in the art, without creative efforts, other accompanying drawings can be obtained according to the accompanying drawings and other embodiments.

To simplify the drawings, the drawings only illustrate members related to the present disclosure, which cannot represent the actual structure of a product. In addition, to make the drawings simple and facilitate understanding, members with the same structure or functions in some drawings, only one of the members can be illustrated, or only one of the members can be marked. In the present disclosure, “a” not only represents “only one” but also “more than one.”

Furthermore, the term “and/or” used in the specification and the appended claims of the present disclosure can represent one or more combinations of the items listed and include these combinations.

In the present disclosure, it should be noted that, unless otherwise specified and limited, the terms “mounting,” “connection,” and “coupled” should be understood broadly. For example, the connection can be a fixed connection, a detachable connection, or an integrated connection. The connection can also be mechanical or electrical. The connection can be a direct connection or an indirect connection through an intermediate medium. The connection can also be a communication of the internal chamber of two elements. For those ordinary skills in the art, the meanings of the above terms in the present disclosure can be understood according to specific situations.

In addition, in the description of the present disclosure, the terms “first,” “second,” etc. are only used to differentiate and should not be construed as indicating or implying relative importance.

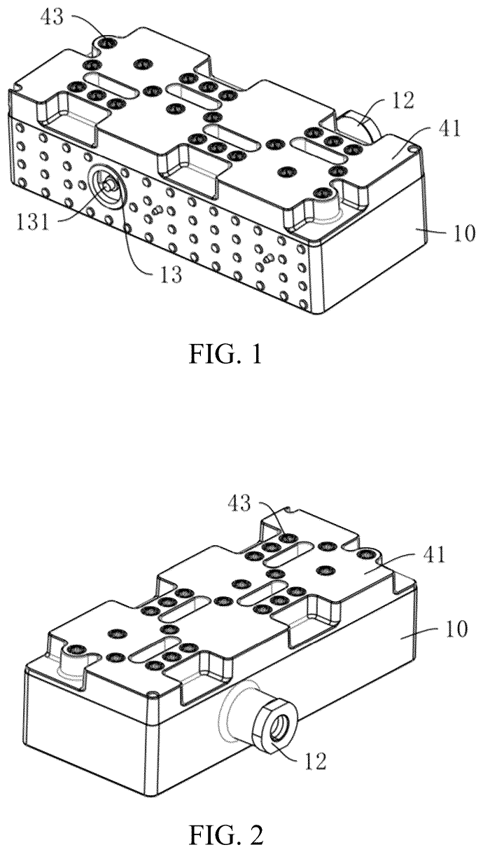

As shown in FIG. 1 to FIG. 11, a metal injection filter of the present disclosure includes a resonator chamber body 10 and a plurality of resonators 20. The resonator chamber body 10 is an enclosure that forms a resonance chamber 11. The plurality of resonators 20 are mounted in the resonance chamber 11. At least one resonator of the plurality of resonators 20 can be molded by a metal injection molding process.

In some embodiments, at least one resonator 20 of the plurality of resonators 20 can be formed in the metal injection molding process. Thus, the resonator 20 can have a higher processing accuracy, which helps to improve the overall performance of the filter.

In some embodiments, at least two resonators 20 can form a resonance unit 30. The resonance unit 30 can be integrally molded by a metal injection molding process.

At least two resonators 20 in the resonance unit 30 can be integrally molded by a metal injection molding process to realize the integral molding of a coupling structure. Thus, the neighboring resonators 20 can be ensured to be coupled with a high-precision. The number of the resonators 20 in the resonance unit 30 is not limited to two and can be three or more. For example, all the resonators 20 in the resonator chamber body 10 can belong to the resonance unit 30. All the resonators 20 in the resonator chamber body 10 can be integrally molded by a metal injection molding process. In some other embodiments, the resonator chamber body 10 can include two or more resonance units 30. Two or more resonance units 30 can be mounted in the resonance chamber 11 of the resonator chamber body 10 after being molded, respectively.

The resonator chamber body 10 can be manufactured by machining or die casting. Then, the resonance unit 30 and/or the resonator 20 can be mounted in the resonance chamber 11. In some embodiments, the resonator chamber 10 may also be formed in a metal injection molding process. Then, the resonance unit 30 and/or the resonator 20 can be mounted in the resonance chamber 11.

In some other embodiments, the resonator chamber body 10 and some resonators 20 in the resonance chamber 11 can be integrally molded by a metal injection molding process. By integrally forming the resonator chamber body 10 and the resonators 20, filters with miniaturization, lightweight, high performance, and high integration can be achieved with smaller extreme dimensions and more precise dimensional tolerances.

For example, a wall thickness of the resonator chamber body 10 that is molded in the metal injection molding process can reach 0.3 mm. Compared to the resonator chamber body 10 that is machined or die-cast, the wall thickness can be reduced. When the overall volume of the resonator chamber body 10 is unchanged, and the wall thickness of the resonator chamber body 10 is reduced, the space of the resonance chamber 11 can be larger, and the insertion loss performance of the filter can be better.

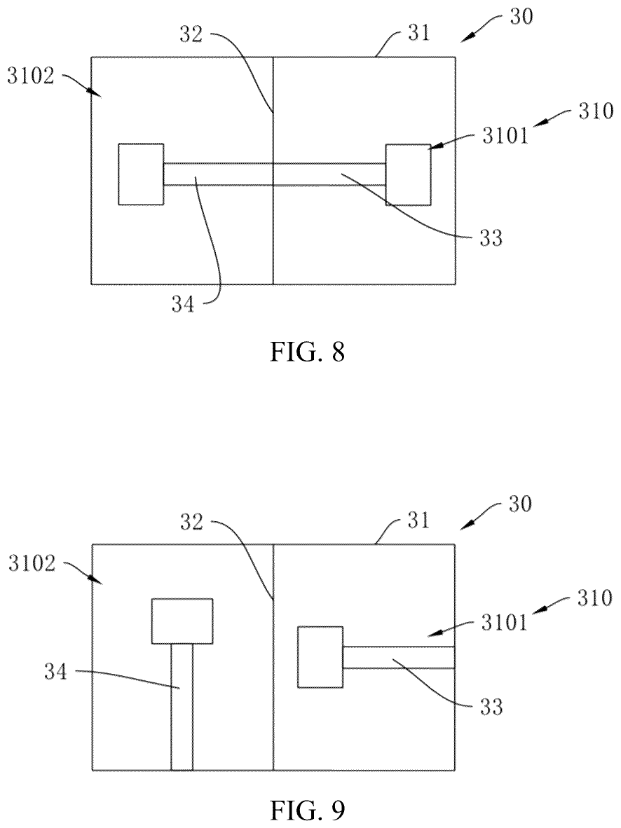

As shown in FIG. 5 to FIG. 11, the resonance unit 30 includes a frame body 31, a partition 32, a first resonator 33, and a second resonator 34. The frame body 31 is an enclosure that forms a container chamber 310. The partition 32 divides the container chamber 11 into a first container chamber 3101 and a second container chamber 3102. The first resonator 33 is located in the first container chamber 3101, and the second resonator 34 is located in the second container chamber 3102. The first resonator 33 and the second resonator 34 are compatible for mutual coupling.

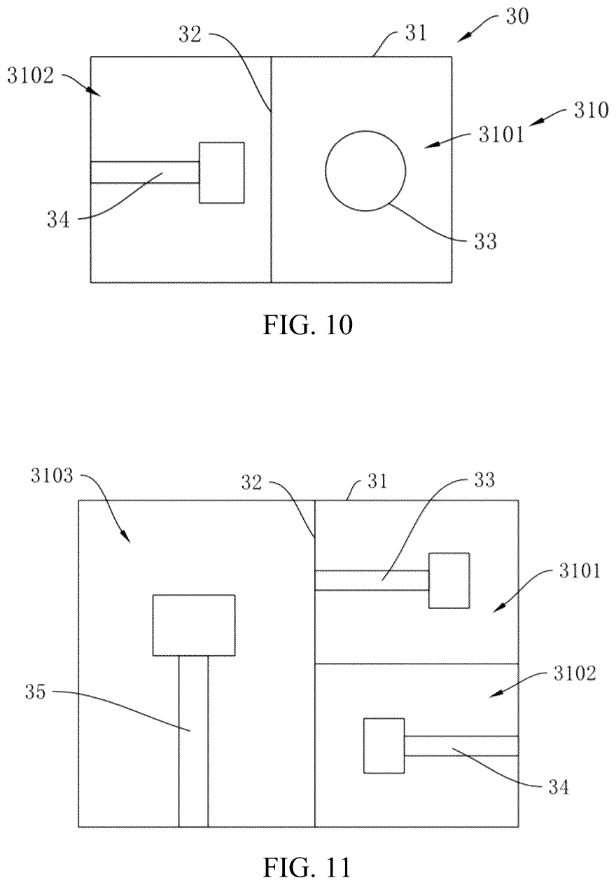

As shown in FIG. 12, in some other embodiments, the container chamber 310 of the resonance unit 30 is not provided with the partition 32. The coupling amount can be adjusted by adjusting a distance between the first resonator 33 and the second resonator 34 in the container chamber 310 or by adjusting the area of the container chamber 310.

As shown in FIG. 5, in some embodiments, the head part of the first resonator 33 corresponds to the head part of the second resonator 34. A coupling window 320 is formed at the partition 32. When the head part of the first resonator 33 corresponds to the head part of the second resonator 34, the first resonator 33 and the second resonator 34 can realize negative coupling. As shown in FIG. 6, the foot part of the first resonator 33 corresponds to the foot part of the second resonator 34, and the first resonator 33 and the second resonator 34 can realize positive coupling. In some embodiments, the first resonator 33 and the second resonator 34 can be coaxially arranged.

As shown in FIGS. 7 and 8, the first resonator 33 and the second resonator 34 are arranged side by side, for example, in parallel. As shown in FIG. 7, the first resonator 33 and the second resonator 34 are arranged in the same direction. That is, the head part of the first resonator 33 corresponds to the head part of the second resonator 34, and the foot part of the first resonator 33 corresponds to the foot part of the second resonator 34. As shown in FIG. 8, the first resonator 33 and the second resonator 34 are arranged in a reverse direction. That is, the head part of the first resonator 33 corresponds to the foot part of the second resonator 34, and the foot part of the first resonator 33 corresponds to the head part of the second resonator 34.

As shown in FIG. 9 and FIG. 10, the first resonator 33 and the second resonator 34 are arranged alternately. As shown in FIG. 9, the first resonator 33 and the second resonator 34 are generally arranged in a horizontal plane. As shown in FIG. 10, the first resonator 33 is located in a horizontal plane, while the second resonator 34 is located in a vertical plane.

As shown in FIG. 11, furthermore, the resonance unit 30 also includes a third resonator 35. The partition 32 divides the container chamber 310 into the first container chamber 3101, the second container chamber 3102, and a third container chamber 3103. The third resonator 35 is located in the third container chamber 3103. The first resonator 33 and the second resonator 34 are respectively coupled with the third resonator 35.

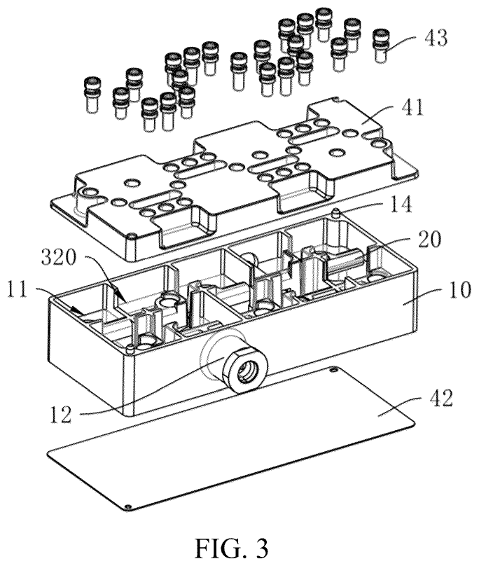

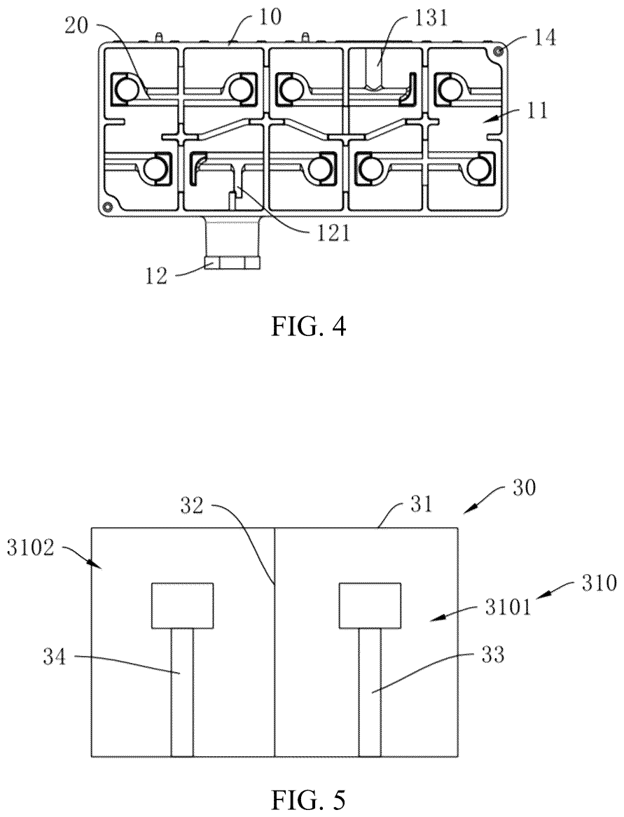

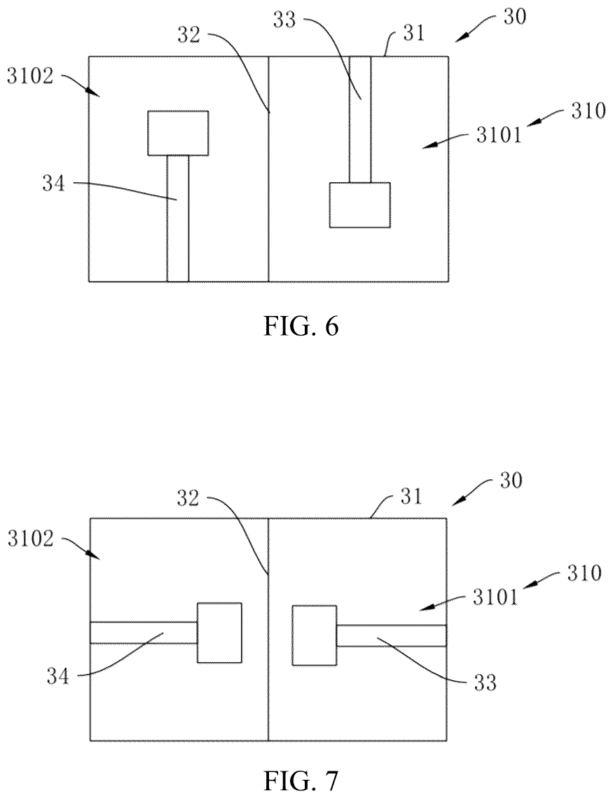

As shown in FIG. 1, FIG. 2, FIG. 3, and FIG. 4, a first connector 12 and a second connector 13 are arranged on a sidewall of the resonator chamber body 10. The first connector 12 and the second connector 13 are respectively connected (e.g., electrically connected) to the resonance chamber 11. The first connector 12 includes a first tap 121 internally connected to the one of the resonators 20. The second connector 13 includes a second tap 131 internally connected to another one of the resonators 20. For example, the first connector 12 can be an input connector, and the second connector 13 can be an output connector.

Furthermore, the metal injection filter can also include a top cover 41, a bottom cover 42, and multiple adjustment modules 43. The top cover 41 and the bottom cover 42 can be covered at the top opening and the bottom opening of the resonator chamber body 10, respectively. The adjustment modules 43 can be located at the top cover 41, extend to the resonance chamber 11, and be configured to adjust the frequency and the coupling amount of the filter.

The adjustment module 43 can include a self-locking screw with a height of 18.2 mm and a tolerance within 0.05 mm.

In some other embodiments, the top cover 41 can include an adjustment member extending into the container chamber 310. The adjustment member can form the partition 32.

The top cover 42 can be fixedly installed at the top opening of the resonator chamber body 10 by brazing, laser welding, soft soldering (tin soldering), screw fixing, etc. Similarly, the bottom cover 42 can also be fixed at the bottom opening of the resonator chamber body 10 by brazing, laser welding, soft soldering (tin soldering), screw fixing, etc. the bottom cover 42 can also have a shielding function.

The top cover 41, the bottom cover 42, and the adjustment module 43 can be molded by a metal injection molding process, or formed in a mechanical die-casting method, or a sheet metal processing method. The specific forming methods of the top cover 41, the bottom cover 42, and the adjustment module 43 do not limit the scope of the present disclosure.

As shown in FIG. 3 and FIG. 4, a first positioning member 14 is arranged at a predetermined position at the top of the resonator chamber body 10. A second positioning member (not shown in the figure) can be arranged at a predetermined position on the top cover 41. When the top cover 41 is mounted at the top opening of the resonator chamber body 10, the first positioning member 14 and the second positioning member can cooperate with each other to cause the top cover 41 to be aligned with the resonance chamber 11. In some embodiments, the first positioning member 14 can be a positioning pin. The second positioning member can be a positioning hole. In some other embodiments, the first positioning member 14 can be the positioning hole, and the second positioning member can be the positioning pin.

Further, FIGS. 3-4 show ten resonators 20 respectively resided in ten resonance chambers 11. The ten resonators 20, the ten resonance chambers 11 and other components (e.g., top cover 41, bottom cover 42, adjustment modules 43, connector 12) together form a whole filter shown in FIG. 3.

In some embodiments, the metal in the metal injection molding process can be selected from one or more combinations of iron-nickel alloy, stainless steel, titanium alloy, nickel-iron alloy, copper, and aluminum. Through the metal injection molding process, the ratio of different types of metals can be adjusted to improve the temperature drift performance of the filter as needed.

It should also be noted that the negative coupling of the metal injection filter of the present disclosure can be generated by the resonator. Relevant adjustment elements can be placed in reasonable positions without affecting the space. Due to sufficient space sensitivity margin, a multi-zero topology structure can be used, including but not limited to a topology structure with 6 chambers and 4 zeros, or 8 chambers and 4 zeros, which provides wider bandwidth, lower loss, and better suppression compared to the existing solution.

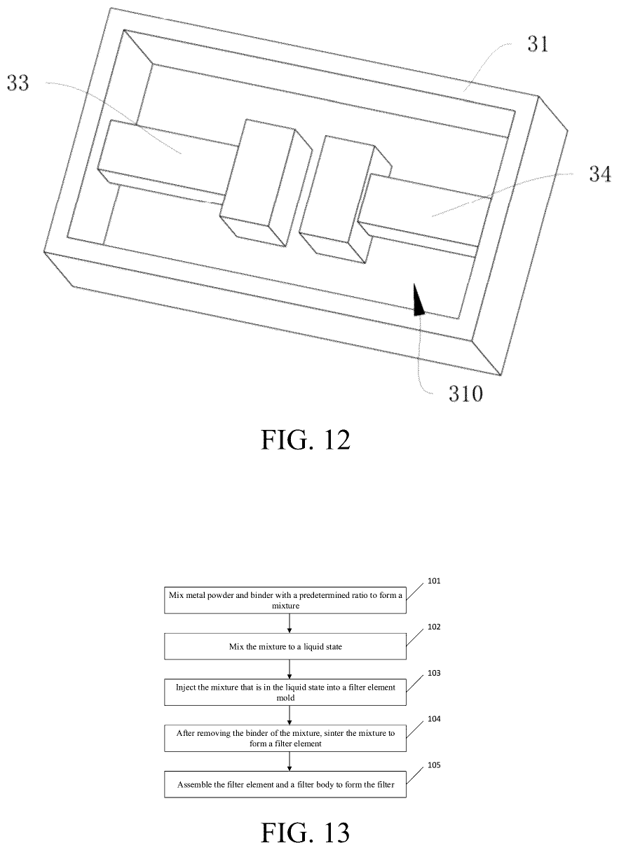

As shown in FIG. 13, according to another aspect of the present disclosure, a method for manufacturing a metal injection filter is further provided. The method includes the following processes.

At 101, metal powder and binder with a predetermined ratio are mixed to form a mixture.

At 102, the mixture is mixed to a liquid state.

At 103, the mixture that is in the liquid state is injected into a filter element mold.

At 104, after removing the binder of the mixture, the mixture is sintered to form the filter element.

At 105, the filter element and the filter body are assembled to form the filter.

In some embodiments, the filter body can include the resonator chamber body 10. The resonator chamber body 10 can surround to form the resonance chamber 11. The resonance chamber 11 can include some resonator mounting positions. The filter element can include at least one resonator 20. The at least one resonator mounting position can be configured to mount the filter element.

In some embodiments, the filter element can include the resonator chamber body 10. The resonator chamber body 10 can surround to form a plurality of resonance chambers 11. The resonance chambers 11 can form a filter. The resonator chamber body 10 and the resonators 20 in the resonance chambers 11 can be integrally injection molded. The filter body can include the top cover 41, the bottom cover 42, and multiple adjustment modules 43. The top cover 41 and the bottom cover 42 can be covered at the top opening and the bottom opening of the resonator chamber body 10, respectively. The adjustment module 43 can be mounted at the top cover 41, extend into the resonance chamber 11, and be configured to adjust the frequency and the coupling amount of the filter.

In some embodiments, at least one sidewall of the resonator chamber body 10 can be integrally formed with the top cover 41 or the bottom cover 42. For example, the top cover 41 can be integrally formed with one sidewall of the resonator chamber body 10. When closed, the top cover 41 and the sidewall can be integrally covered at the resonator chamber body 10.

It should be noted that the above embodiments can be freely combined as needed. The above are only some embodiments of the present disclosure. It should be pointed out that for those ordinary skills in the art, without departing from the principles of the present disclosure, various improvements and modifications can be made. These improvements and modifications are within the scope of the present disclosure.

What is claimed is:

1. A metal injection filter comprising:
a resonator chamber body being an enclosure that forms a resonance chamber; and
a plurality of resonators mounted in the resonance chamber, at least one resonator of the plurality of resonators being molded by a metal injection molding process.

2. The metal injection filter according to claim 1, wherein:
at least two resonators of the plurality of resonators form a resonance unit; and
the resonance unit is integrally molded by the metal injection molding process.

3. The metal injection filter according to claim 1, wherein:
the resonator chamber body and the plurality of resonators in the resonance chamber are integrally molded by a metal injection molding process.

4. The metal injection filter according to claim 2, wherein the resonance unit includes:
a frame body being an enclosure that forms a container chamber; and
a first resonator and a second resonator arranged in the container chamber at an interval and being compatible for mutual coupling.

5. The metal injection filter according to claim 4, wherein the resonance unit further includes:
a partition mounted in the container chamber and configured to divide the container chamber into a first container chamber and a second container chamber, the first resonator being located in the first container chamber, and the second resonator being located in the second container chamber.

6. The metal injection filter according to claim 5, wherein:
a head part of the first resonator corresponds to a head part of the second resonator, and a coupling window is formed at the partition.

7. The metal injection filter according to claim 5, wherein the first resonator and the second resonator are arranged coaxially, and a foot part of the first resonator corresponds to a foot part of the second resonator.

8. The metal injection filter according to claim 5, wherein:
the first resonator and the second resonator are arranged side by side on a same row; and
the first resonator and the second resonator are arranged in a same direction or a reverse direction.

9. The metal injection filter according to claim 5, wherein the first resonator and the second resonator are arranged alternatively.

10. The metal injection filter according to claim 8, wherein:
the resonance unit further includes a third resonator;
the partition divides the container chamber into a first container chamber, a second container chamber, and a third container chamber;
the third resonator is located in the third container chamber; and
the first resonator and the second resonator are respectively coupled with the third resonator.

11. The metal injection filter according to claim 5, wherein the resonator chamber body is formed in a plating or die-casting process.

12. The metal injection filter according to claim 5, wherein:
a first connector and a second connector are arranged at a sidewall of the resonator chamber body, the first connector is electrically connected to the first resonance chamber, the second connector is electrically connected to the second resonance chamber, a first tap that is connected to the first resonator is arranged in the first connector, and a second tap that is connected to the second resonator is arranged in the second connector; and
the metal injection filter further includes a top cover, a bottom cover, and multiple adjustment modules, a top opening and a bottom opening of the resonator chamber body are respectively covered by the top cover and the bottom cover; and
the multiple adjustment modules are located at the top cover and extend to the resonance chamber, and are configured to adjust a frequency and a coupling amount of the filter.

13. The metal injection filter according to claim 12, wherein:
the top cover includes an adjustment member extending into the container chamber; and
the adjustment member forms the partition.

14. The metal injection filter according to claim 12, wherein:
a first positioning member is arranged at a predetermined position of the resonator chamber body;
a second positioning member is arranged at a predetermined position of the top cover; and
when the top cover is mounted at the top opening of the resonator chamber body, the first positioning member and the second positioning member cooperate with each other to cause the top cover to be aligned with the resonance chamber.

15. The metal injection filter according to claim 12, wherein a metal in the metal injection molding process includes one or more of iron-nickel alloy, stainless steel, titanium alloy, nickel-iron alloy, copper, and aluminum.

16. A method for manufacturing a metal injection filter comprising:
mixing a metal powder and a binder with a predetermined ratio to form a mixture;
mixing the mixture to a liquid state;
injecting the mixture in the liquid state into a filter element mold;
after removing the binder of the mixture, sintering the mixture to form a filter element; and
assembling the filter element and a filter body to form the filter.

17. The method for manufacturing the metal injection filter according to claim 16, wherein:
the filter body includes a resonator chamber body;
the resonator chamber body is an enclosure that forms a resonance chamber;
the resonance chamber includes a plurality of resonator mounting positions;
the resonator element includes at least one resonator; and
the resonator element is mounted at least one resonator mounting position.

18. The method for manufacturing the metal injection filter according to claim 16, wherein:
the resonator element includes a resonator chamber body;
the resonator chamber body is an enclosure that houses a plurality of resonance chambers and a plurality of resonators;
the plurality of resonance chambers and the plurality of resonators form at least one filter;
the plurality of resonance chambers and the plurality of resonators are integrally injection molded.

19. The method for manufacturing the metal injection filter according to claim 16, wherein:
the filter body includes a top cover, a bottom cover, and a plurality of adjustment modules;
the top cover and the bottom cover are covered at a top opening and a bottom opening of the resonator chamber body; and
the plurality of adjustment modules are mounted at the top cover and extend into one or more resonance chambers included in the resonance element, and configured to adjust a frequency and a coupling amount of the filter.

20. The method for manufacturing the metal injection filter according to claim 19, wherein at least one sidewall of a resonator chamber body that houses the resonance chamber and the top cover or the bottom cover are integrally formed.
